(19) United States
(12) Patent Application Publication
(10) Pub. No.: US 2009/0057228 A1
(43) Pub. Date: Mar. 5, 2009

(54) SYSTEM AND METHOD OF FILTERING USING STRATIFIED ACTIVATED CARBON

(75) Inventors: James R. Graham, Fountain Valley, CA (US); Robert Craw, Danville, CA (US)

Correspondence Address: LOWRIE, LANDO & ANASTASI, LLP;U0105, ONE MAIN STREET, SUITE 1100, CAMBRIDGE, MA, 02142, US

(73) Assignee: SIEMENS WATER TECHNOLOGIES CORP., Warrendale, PA (US)

(21) Appl. No.: 11/847,081

(22) Filed: Aug. 29, 2007

(51) Int. Cl. B01D 15/04; B01D 24/00; C02F 1/42

(52) U.S. Cl. 210/661; 210/269; 210/290; 210/681

(57) ABSTRACT

A stratified bed of activated carbon having regions of functionalized and non-functionalized activated carbon can be utilized to remove contaminants from fluids such as groundwater. The functionalized region has activated carbon particles comprising a cationic or anionic compound that can remove organic or inorganic anionic or cationic compounds from the fluid to be treated. The non-functionalized region comprises powdered or granular activated carbon or adsorbent media downstream of the functionalized region and captures any leaching species or compounds from the functionalized region.

### BACKGROUND OF INVENTION

1. Field of Invention

The present invention relates to filtration systems that can be used to treat water, such as groundwater, and, in particular, to filtration systems and techniques that utilize functionalized activated carbon.

2. Discussion of Related Art

There is growing public concern related to the presence of certain contaminants such as perchlorate ions in drinking water. Granular activated carbon (GAC) can be used as a filter media to remove contaminants from fluids such as groundwater. Further, activated carbon can be functionalized or tailored to improve treatment effectiveness. For example, Cannon et al., in U.S. Pat. Nos. 6,881,348 and 7,157,006 as well as U.S. Patent Application Publication No. US 2006/0102562, disclose a method for perchlorate removal from groundwater.

### SUMMARY OF INVENTION

One or more aspects of the invention pertain to a method of facilitating fluid filtration in a filtration bed. The method can comprise one or more acts of providing a first activated carbon layer at least a portion thereof comprising providing a first activated carbon layer, at least a portion thereof comprising functionalized activated carbon, and providing a second activated carbon layer in fluid communication downstream of the first activated carbon layer.

Further aspects of the invention can involve a filtration bed. In accordance with such aspects, one or more embodiments of the filtration bed can comprise a first activated carbon layer comprising functionalized activated carbon particles and a second activated carbon layer in fluid communication with the first activated carbon layer.

Still further aspects of the invention can pertain to a method of treating water. One or more embodiments in accordance with such aspects can comprise one or more acts of introducing water to be treated into a stratified filter bed comprising an upstream layer of functionalized activated carbon particles and a downstream layer of non-functionalized activated carbon particles.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic representation of an embodiment in accordance with some aspects of the invention showing a filtration bed comprising stratified filtration media; and

FIG. 2 is a chart showing the results of Example 1 in accordance with some aspects of the invention.

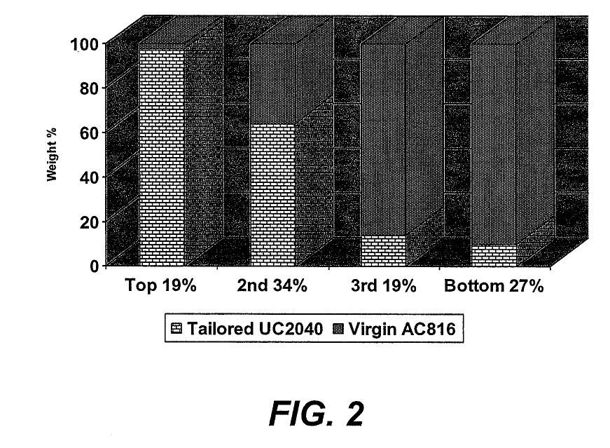

### DETAILED DESCRIPTION

This invention is not limited in its application to the details of construction and the arrangement of components set forth in the following description or illustrated in the drawings. The invention is capable of other embodiments and of being practiced or of being carried out in various ways.

One or more aspects of the invention pertain to treating a fluid to remove at least a portion of at least one undesirable species therefrom. Other aspects of the invention can pertain to filtration system and/or subsystems that can remove or at least reduce a concentration of at least one compound or species from the fluid to be treated. Still further aspects of the invention can be directed to facilitating removing or reducing a concentration of at least one species from a fluid. For example, one or more aspects of the invention can be directed to systems and techniques that treat groundwater, and in particular, groundwater contaminated by at least one undesirable compound or species or complex thereof.

In accordance with one or more particular aspects of the invention, one or more embodiments of the systems and techniques thereof can involve a filter or filtration bed comprising filtration media constructed and arranged to remove or reduce a concentration of at least one compound or species from a fluid. The filter bed can comprise one or more layers, at least a portion of one or more thereof comprised of adsorbing media. In some cases, at least a portion of one or more layers of the filter bed can comprise media such as activated carbon particles that can, for example, adsorb or otherwise bind one or more species or compounds from a fluid. In other embodiments of the invention, the filter bed can comprise a first layer comprising a first adsorbing media and one or more layers comprising a second media. Thus, in some cases, a filter bed comprising activated carbon particles can be utilized to at least partially reduce a concentration of at least one undesirable species from a fluid. The term “layer,” as used herein, denotes a portion or sections of a bed or stack of treating media having one or more characteristics that distinguishes the portion from other portions or sections of the media. Thus, a portion of a media bed can have a first characteristic value that differs from a characteristic value of another portion of the bed. For example, an intrinsic property of a portion of the bed can be less than the intrinsic property of another portion of the bed. In accordance with some particular embodiments of the invention, the bed can comprise particles having an average density that is less than the average density of other particles of the bed. References herein to the phrase “distinct layers” are to be understood as not requiring that the different layers be entirely separate from one another. A “distinct layer” of filtration media is one that is arranged such that a substantial part of the layer of filtration media is at a different relative position along a flow path. Some intermixing between the distinct layers, especially at the interface between the layers, is acceptable and such intermixing does not render the layers non-distinct. The term “stratified” with reference to layers or regions does not preclude some intermixing or commingling between the layers. Indeed, a stratified bed of the invention can comprise particles having a continuum of one or more characteristics. Thus, for example, a filter bed of the invention can comprise particles with a gradient of increasing, or decreasing, shape factor, particle size and/or particle density.

Still further embodiments of the invention can be practiced utilizing beds having layers characterized by the presence or absence of a characteristic or property. For example, various filter bed embodiments of the invention can comprise a first layer having a first characteristic and one or more layers characterized as lacking the first characteristic and/or as having an alternative characteristic. Alternatively, the first portion or layer can lack a particular characteristic or property whereas, in another region or layer of the filter media, at least a portion or component thereof can have the characteristic or property.

Various advantageous embodiments of the invention, however, utilize beds having one or more layers characterized from another or other layers by having different characteristic properties. Thus, in some cases, the bed can have a first layer of adsorbing media particles having a first characteristic value and a second characteristic value and a second layer of particles having a different first characteristic value and a different second characteristic value. In some cases, the one or more characteristics or properties can facilitate at least a partial separation or segregation of particles or components of the bed. For example, the filter bed of the present invention can have a first layer having particles with a first average density value and a first average particle size value and a second layer having particles with a second average density value and a second average particle size value. Some particularly advantageous embodiments of the invention, moreover, can involve filter beds comprising a first layer of particles having a first characteristic along with a first average density and/or a first average particle size as well as one or more layers of particles having a different average density and/or a different average particle size but further characterized as lacking the first characteristic.

The various aspects of the invention can involve any characteristic or property of the particles or layers of the various filter bed embodiments of the invention including, but are not limited to, surface treatment, density, particle size, particle shape, porosity or pore density, and pore size. In some advantageous embodiments relative to some aspects of the invention, the one or more characteristics or properties involve adsorbing media lacking or having a surface treatment. In still other particularly advantageous embodiments relative to further aspects of the invention, the one or more characteristics or properties involve adsorbing media that is tailored or functionalized to preferentially attract, sequester, and/or retain at least one target species or compound or types of target species or compounds from a fluid. In some aspects of the invention, at least a portion of particles or granules of one or more filter beds of the invention can be functionalized to attract a target species and, preferably, also have a characteristic that facilitates separation thereof from other similar, typically, non-functionalized particles or granules comprising the filter bed.

In still further embodiments of the invention, all active components, such as the adsorbing media, of the filter bed can be contained in a single housing. For example, the filter bed, comprising at least one layer of adsorbing media, which has a first characteristic, and further comprising at least one layer of the same or different type of media, but preferably lacking the first characteristic, can be contained in a unitary housing or vessel. In still other cases, one or more embodiments of the invention can involve a lead filtration vessel and a lag filtration vessel, compositionally the same, wherein the lag filtration vessel serves as a secondary barrier. This embodiment is based on the observation that even though the first adsorbent media may be treated or impregnated with up to about 30% of its weight with a functionalizing species, its density when fully wetted in water is very similar to that of virgin carbon.

In accordance with some aspects of the invention, the systems and techniques of the invention can utilize particles or granules constructed and arranged to be stratified into two or more layers. Thus, in some embodiments of the invention, the bed can comprise granular components having at least one separation, e.g., a settling, characteristic. Particularly preferred embodiments of the systems and techniques of the invention may utilize components that have a plurality of separation characteristics. For example, one or more embodiments of the invention can comprise granular activated carbon having a broad distribution of particle sizes and/or densities to facilitate stratification such that during fluidizing operations, such as backwashing, smaller and/or lighter particles therein predominantly settle above larger and/or denser particles of the bed.

The phrase “broad distribution” describes a characteristic and pertains to a statistic scattering of the characteristic such that a predominant, e.g., greater than 90% of the statistical components, fall within two or three standard deviations of the mean value of the characteristic. In contrast to the phrase “narrow distribution” statistically describes a scattering wherein the predominant values are within one standard deviation of the mean value. To be sure, the various embodiments of the invention can involve particles having a narrow distribution of at least one characteristic. For example, the filter bed of the invention can comprise at least one layer of adsorbent media having a narrow particle size distribution and/or narrow density distribution.

As used herein, the term average diameter refers to an averaged dimension of particles or granules as measured across the particles or granules assumed to be a sphere of the same volume. The invention, however, is not limited to utilizing spherically-shaped or substantially spherically-shaped media. For example, at least a portion of the media grains or particles can comprise disc-shaped and cylindrically-shaped granules characterized by having an aspect ratio of greater than 1:1, or a ratio of a larger dimension relative to a shorter dimension. Indeed, particles having alternative shapes may be utilized that facilitate one or more aspects of the invention. For example, the bed may comprise particles or granules that are shaped and/or selected to have a shape factor that deviates from spherical thereby exhibiting a reduced settling rate relative to a spherically-shaped particle of substantially the same volume. Further, one or more embodiments of the invention may utilize granular media having a bimodal or multi-modal density distribution, a bimodal or multi-modal particle size distribution, and a plurality of shapes or shape factors. The invention, however, is not limited to particles of discrete shapes and the latter characteristic may be expressed as distribution of shape factors. Indeed, some particularly advantageous embodiments of the systems and techniques of the invention can have beds that utilize particles or granules that have an average shape factor of less than 0.8 as well as granules that have an average shape factor greater than 0.8. Other modalities are contemplated and the invention is not limited to the exemplary modes and/or values disclosed herein. Shape factor can be characterized according to relative dimensions of the particle and can be represented as a function, such as a ratio of a longest dimension of a typical particle to its shortest dimension and/or an intermediate dimension. The technique disclosed by Corey, i.e., the Corey Shape Factor, may be utilized to quantify the shape factor.

In accordance with some embodiments, the systems and techniques of the invention can utilize adsorbing media that serves to capture at least one target species or compound from an upstream portion of the filter bed. For example, the filter bed can comprise at least one layer or region of media that can serve as a barrier or secondary treatment stage that can prevent or at least reduce the likelihood of producing an unacceptable treated water stream by, for example, capturing, at least one undesirable or target species leaching from an upstream portion of the filter bed. The filter bed, in some embodiments of the invention, can comprise non-functionalized media that captures any undesirable species from, for example, the first layer of adsorbing media in the bed. Alternatively, or in conjunction with other embodiments of the invention, the filter bed can comprise, consist essentially of, or consist of a first layer or region of adsorbing media functionalized with a first compound and further comprise, consist essentially of, or consist of a downstream second layer or region of adsorbing media functionalized with a different compound that captures, sequesters, and/or retains any undesirable species or compounds from the upstream first layer. In accordance with still further embodiments of the invention, the filter bed can comprise at least one non-functionalized media layer that serves as a secondary barrier for the one or more functionalized carbon media layers. Still further embodiments of the invention involve one or more mixed layers or regions of functionalized adsorbing media and one or more layers or regions of non-functionalized adsorbing media. The one or more mixed layers of media can comprise granules having a first functionality and granules having a second functionality.

Non-limiting examples of adsorbing or absorbent media that may be utilized in various components or embodiments of the invention include adsorbent powder or granules like carbon, e.g., bituminous coal based carbon, as well as ion exchange media.

In some advantageous embodiments of the invention, the filter bed comprises activated carbon media with distinct characteristics in a single housing or vessel. For example, a stratified filter bed can have a one or more functionalized layers upstream of one or more non-functionalized layers. The filter bed may be disposed in a column, such as an adsorber, that can contain 20,000 or more pounds of media. The filter bed media can be fluidized by backwashing of the bed such that the media comprising at least two distinct layers is stratified and segregated, typically on the basis of their different particle sizes and densities, after fluidization. In one embodiment of the present invention, this can be accomplished if the density and/or particle size of the non-functionalized carbon particles is greater than the density and/or particle size of the functionalized carbon. Alternatively or in conjunction with having a greater relative density and/or larger particle size, the non-functionalized particles can further have a lower shape factor that further facilitates a greater settling rate relative to the functionalized particles. Such configurations would typically be advantageously selected for applications that are directed to utilizing non-functionalized media downstream and below the functionalized media layer or region. Thus, in configurations wherein the non-functionalized media layer is disposed downstream and above the functionalized media layer, the density and/or size of the non-functionalized media particles are selected to be less than the media particles of the functionalized layer or region.

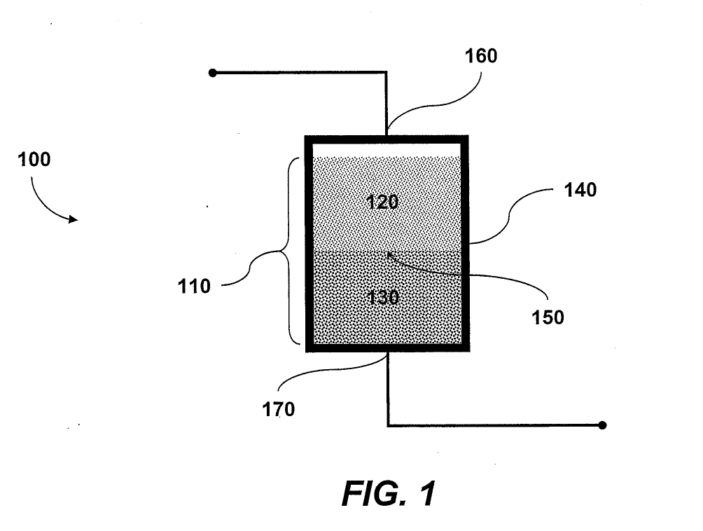

FIG. 1 exemplarily illustrates an embodiment pertinent to one or more aspects of the invention. In FIG. 1, a filtration system 100 or subsystem has a stratified filtration bed 110 with first layer or region of media 120 and a second layer of media 130, contained in a vessel or housing 140. An interface or boundary region 150 at least partially defines a boundary between the layers 120 and 130. Some mixing or mingling of particles of the two layers may occur in boundary region 150. In the illustrated embodiment, fluid to be treated from a source (not shown) can be introduced at at least one inlet port 160 of filter vessel 140. Fluid, after being treated through filter bed 110, can exit at at least one outlet port 170 of vessel 140 and be directed to storage, further unit operations, and/or a point of use (not shown). In some particularly contemplated embodiments of the invention, at least a portion of particles of the first or upstream layer 120 can also be functionalized with one or more agents thereby disposing one or more cationic or anionic species on a least a portion of the particles or granules thereof. Second or downstream layer 130 can be non-functionalized or be functionalized with a different active species. The amount of second or downstream layer or region 130, as bed volume or specific pore surface area, can be relative to the amount of the first or upstream layer 120 but is preferably sufficient to capture any leachant in a stream from the first upstream layer. For example, the amount of the second layer can be at least about 10% of the bed volume of the first layer, but can be at least about 25%. In other cases, the bed volume of the second layer is less than 90%, or even less than 50%, of the bed volume of the first layer.

Filtration system 100 can further comprise one or more unit operations (not shown) upstream and/or downstream of filter bed 110. For example, a unit operation can be used to adjust a pH of the fluid stream to be treated to facilitate adsorption in filter bed 110 and/or improve efficiency in any downstream process. Other pre-treatment unit operations upstream of filter bed 110 that may be utilized in some aspects of the invention include, for example, heating and/or cooling systems that provide thermodynamically advantageous conditions in a unit operation along the filtration train of system 100 including, but not limited to filter bed 110. In still other embodiments of the invention, one or more settling or separation systems, or other analogous assemblies that remove at least a portion of large fragments or debris from the fluid stream to be treated, may be utilized in a pre-treatment stage upstream of filter bed 110.

In further embodiments of the invention, the at least two media layers may be disposed in a side by side configuration rather than in a vertically stratified configuration. In such embodiments, the upstream region can be segregated from the downstream region by selecting functionalized and non-functionalized adsorbent media that are conducive to slurry flow and further regulating the fluid flow rate or energy and induce settling of the functionalized granules before the non-functionalized granules thereby promoting settling of the latter at a downstream location. The filtration system 100 may be shaped or configured in various ways, including a cylindrical configuration, a conical configuration, a boxlike configuration or any other configuration desired for a particular application.

Functionalization of the media particles can involve disposing at least one cationic species or at least one anionic species on the particles or one or more precursor compounds that be converted to at least one charged moiety. The functionalizing species or functional moiety can be an inorganic or an organic moiety and can further comprise segments that facilitate adsorption thereof on the adsorbing media particles. Non-limiting examples of functionalizing species or compounds that may be utilized in one or more embodiments of the invention include those comprising anionic or cationic moieties or compounds such as those selected from the group consisting of quaternary ammonium compounds, amine compounds, iminic compounds, imidic compounds, amidic compounds, pyridinic compounds, pyrrolic compounds, and precursors, derivatives, or analogs thereof. As used herein, the term “functionalized” encompasses the term “tailored.”

For example, ammonia can be used as precursor compound and be rendered as a functionalizing agent or loaded on adsorbing media by exposing the media to gaseous ammonia, typically at an elevated temperature of at least 500° C. for a period sufficient to allow at least partial adsorption on the media. Particular non-limiting examples of species or precursor compounds that may be utilized to functionalize the various media of the invention include cationic compounds including methonium halide compounds such as decamethonium bromide, decamethonium chloride, hexamethonium bromide, and hexamethonium chloride; ferric and ferrous salts; pyridinic halide compounds such as hexadecylpyridinium bromide and cetylpyridinium chloride; ammonium halide compounds such as ammonium chloride and ammonium bromide; organic ammonium halide compounds such as trimethylammonium chloride and trimethylammonium bromide, octyltrimethylammonium chloride, octyltrimethylammonium bromide, decyltrimethylammonium chloride, decyltrimethylammonium bromide, tetraethylammonium chloride, benzyldimethylammonium chloride, tetradecyltrimethylammonium chloride, tetradecyltrimethylammonium bromide, tetradecylammonium bromide, tetradecylammonium chloride, tributylheptylammonium chloride, tributylheptylammonium bromide, and hydroxyl ammonium halides; amide compounds such as acrylamide; precursor compounds that may produce dimethylaminic moieties; aminium halide compounds such as domiphen bromide, domiphen chloride or dodecyltrimethylammonium chloride; choline halide compounds such as benzoylcholine iodide, benzoylcholine chloride, benzoylcholine bromide, and acetylthiocholine chloride, acetylthiocholine iodide, and methacholine halides and other chlorocholine halide compounds; and betaine hydrohalide compounds.

Anionic compounds or species or precursors that may be exemplarily utilized as functionalizing agents in accordance with various embodiments of the invention include, but are not limited to, alkyl or aryl phosphates, sulfonates, and carboxylates or acid analogs thereof. For example, the carboxylic acid compounds can be fatty acids such as lauric acid, myristic acid, palmetic acid and stearic acid. Such compounds typically have between about eight to about twenty aliphatic and/or aromatic segments and may be rendered anionic before and/or during functionalization of the media. Unsaturated fatty acids such as oleic acid, linoleic acid, as well as aromatic acids derivatives or analogs, such as benzoic acid, may also be advantageously utilized to functionalize media in accordance with some embodiments of the invention. Saturated fatty acids may be utilized instead of or with one or more of any of the unsaturated fatty acids or the aromatic fatty acids.

Non-functionalized media of the invention may comprise, consist, or consist essentially of, for example, activated carbon, as powdered activated carbon, granular activated carbon, and/or ion exchange media. In such embodiments of the invention, the ion exchange media is typically selected to be attractive to capture any functional moieties that may be released from the functionalized layer. For example, cationically selective ion exchange media may be used with activated carbon functionalized with cationic quaternary amines. Alternatively, the ion exchange media may comprise a mixture of anionic and cationic media to capture any leaching functionalizing moieties and any target compounds in the fluid to be treated that may breakthrough any of the functionalized layers.

In accordance with some particular embodiments of the invention, at least a portion of the upstream layer of filtration media may comprise granular activated carbon which has been functionalized by the addition of a positively or negatively charged moiety such as a quaternary ammonium compound, or more specifically cetylpyridinium chloride (CPC). Functionalizing agents other than, or in addition to, CPC may be used in alternate embodiments. At least a portion of the downstream layer of filtration media 30 may comprise non-functionalized GAC, and in some embodiments may be virgin GAC or re-activated GAC. In alternative embodiments of the invention, the at least two layers of filtration media 120 and 130 may be characterized such that at least a portion of lower layer 130 comprises functionalized adsorbing media and the upper layer of filtration media 120 substantially comprises non-functionalized activated carbon particles. In such alternative configurations, filter vessel 140 has a lower inlet port 170 fluidly connected to the source of fluid to be treated and upper outlet port 160. Thus, the inlet ports may be located at or near the top of the filtration bed and the fluid outlet ports may be located at or near the bottom of the filtration bed.

Preferably, at least a portion of the upstream layer of functionalized activated carbon particles may be characterized by a particle size smaller than non-functionalized activated carbon particles of the downstream layer. More preferably, at least a portion of the functionalized activated carbon particles may be characterized as having a particle density less than the density of the non-functionalized activated carbon particles.

Further embodiments of the invention can involve filter beds having at least one additional layer or region. Thus, for example, filtration bed 110 can further comprise a third layer or region comprising functionalized media with a different charged moiety. The third layer can be fluidly disposed between the first functionalized layer and the non-functionalized layer or stage.

Appropriate particle sizes for the layers of filtration media will be known to those skilled in the art. An exemplary, but not limiting example of particle sizes in one embodiment is a mesh size of about 20×50 for the upstream layer of filtration material and a mesh size of about 12×30 for the downstream layer of filtration material.

A plurality of filtration beds may be connected serially or in parallel. Further, monitoring devices (not shown) may be disposed along the treatment train including, for example, in the one or more filtration beds or other treatment units, to monitor the levels or concentration of one or more target species or otherwise provide an indication of treatment efficiency. Also not illustrated, pumps may be utilized to facilitate the flow of fluid through the system.

The filtration bed 110 can be prepared by providing a first activated carbon in the filtration bed, providing a second activated carbon in the filtration bed distinct from the first activated carbon in terms of at least one characteristic, preferably, density and particle size, and passing a fluid through the first and second activated carbon at a velocity or flow rate that fluidizes the bed. The first and second activated carbon can then become stratified into layered regions. Typically, the bed will have an upper layer with a predominant concentration of particles having lower density and larger particle size and a lower layer with a predominant concentration of particles with higher density and larger particle size.

The systems and techniques of the invention utilizing the one or more filtration embodiments may be utilized to treat, remover, or at least reduce a concentration of one or more species in a fluid. The fluid to be treated may be water having one or more contaminants such as, but not limited to, undesirable compounds including perchlorates, arsenates, bromates, or chromates as well other government regulated species typically at levels as low as 1 ppb.

The term “passes through” as used herein also encompasses the term “passes over.” As the fluid passes through the layer of GAC, at least a portion of contaminants such as perchlorate ions are adsorbed onto the GAC. Particulate matter may also be removed from the fluid. Moreover, as the fluid passes through the upstream layer of GAC, some of the functionalizing agent or agents which may have been applied to the GAC may leach from the GAC and into the fluid. The fluid can then flow to the downstream layer. In the downstream layer, any functionalizing agents which may have leached into the fluid are removed by adsorption. Thus, aspects of the invention utilize a filter bed having a plurality of treatment targets.

In accordance with still further aspects of the invention, the level of contaminants in the treated fluid leaving the filtration bed may be monitored. Upon detection of at least one target species in the treated fluid stream, the filter bed may be considered as saturated and then be isolated from service and regenerated or re-activated. An alternative filtration train may be placed in service instead. Relevant embodiments thereof may advantageously utilize or maximize the total adsorptive capacity of the filter bed. In other cases, however, the first filtration train may be utilized according to a pre-determined schedule and an alternate train may be used after a pre-determined service period. The pre-determined period may be defined in situ and typically depends on several factors including, but not limited to, the bed capacity, the concentration of the target contaminants, the flow rate of the fluid to be treated, as well as variable considerations that can affect adsorption efficiency such as the pH and/or temperature of the fluid.

Re-activation may be effected by conventional techniques including, but not limited to, thermal regeneration with counter or co-current flowing gases or liquids or by adopting a moving bed system through a regenerating furnace. Regeneration, however, need not be performed in situ and the loaded absorbers may be sent off-site.

The function and advantages of these and other embodiments of the invention can be further understood from the example below, which illustrates the benefits and/or advantages of the one or more systems and techniques of the invention but do not exemplify the full scope of the invention.

### EXAMPLE

This example demonstrates the operation of one embodiment of the invention. A mesh support screen was installed near the bottom of an approximately 18 inches tall column having a diameter of about four inches. A pump with a capacity of 0.5 to 3 gpm was fluidly connected in a recirculation loop. The re-circulation loop was connected to allow water circulation through the column either in an up flow or a down flow direction. About 600 g of granular activated carbon, UC1240, was placed in the column. The UC1240 GAC was previously soaked in water to remove air from the carbon pores. The column was operated in an up flow direction at a flow rate that provided an about 20% bed expansion. The effluent water was directed drain for about one hour to thoroughly wash the carbon. A closed loop configuration was then used and 150 grams of CPC, dissolved in water, was added to the loop. After one hour of circulation, the flow direction was changed to down flow. After 4.5 hours the CPC concentration in the loop was measured to be about 6,720 mg/L. After circulating for 24 hours, the CPC concentration in the water was measured to be 3,520 mg/L. After circulating for about 96 hours, the CPC concentration was measured to be about 1,280 mg/L. The residual tailoring agent concentration indicated that the CPC loading on the carbon was about 23.3 wt %. The CPC-functionalized GAC was next backwashed in an up flow direction with tap water for about 2 hours with the effluent being sent to the drain.

A wet density measurement of the functionalized carbon was made by retrieving some of the carbon granules from the apparatus, surface drying it, and measuring the density in accordance with ASTM D 2854. The density value was measured to be 0.706 g/cc.

The wet density of a sample of virgin AC816 GAC was measured after soaking the sample in hot water, followed by an overnight soak, and after washing it to remove fines. After surface drying a sample of the non-functionalized AC816 GAC, the wet density was measured and found to be 0.726 g/cc. The higher density of the virgin AC816 GAC compared to the functionalized UC1240 GAC suggested that separation can be effected by backwashing and bed stratification.

The functionalized UC1240 granules were wet screened and a −20+40 mesh (“Tailored UC2040”) fraction was collected. About 185 grams (dry basis) of wet AC816 granules and about 150 grams of wet functionalized UC2040 granules were placed in the functionalizing apparatus. The apparatus was operated in an up flow direction at a water flow rate to effect an about 40% bed expansion for about 20 minutes. At five minute intervals, the water flow rate was incrementally reduced so that the bed expansion decreased to about 30%, then to about 20%, then to about 10%, and then to zero. This procedure was used to stratify the bed, based on density and particle size, during back washing.

The stratified bed was removed in approximately 25% portions: the top 19% by volume was designated as the top region, the next 34% was designated as the second region, the next 19% was designated as the third region, and the remaining 27% was designated as the bottom. Each segregated region was dried and their particle size distribution was measured.

Table 1 lists some characteristic of the segregated regions. As also illustrated in FIG. 1, separation or stratification of the bed can be effected to provide first functionalized activated carbon layer and a second non-functionalized activated carbon layer. Moreover, because the cationic quaternary ammonium functionalized activated carbon effectively removes or reduces the concentration of target contaminants, it is expected that the various filter bed embodiments of the invention can provide at least one secondary barrier that captures any leached functionalizing agents and prevent any breakthrough of perchlorate contaminants and produce treated water that meets or exceeds current California DHS requirements. That is, if any CPC leaches from the functionalized carbon layer that, it can be adsorbed by the secondary layer comprising virgin AC816 GAC that surrounds the functionalized carbon particles or is disposed downstream thereof.

It is believed that granules with greater differences in densities and more defined if not complete segregation of the particles can be achieved.

TABLE 1

| | Top | Second | Third | Bottom |
|---|---|---|---|---|
| | 19% | 34% | 19% | 27% |
| Total Sample Weight, | 56.4 | 101.9 | 57.4 | 81.1 |
| (grams) | | | | |
| Functionalized UC2040 | 55.0 | 65.1 | 7.9 | 8.0 |
| (−16 mesh) | | | | |
| (grams) | | | | |
| Non-functionalized AC816 | 1.5 | 36.8 | 49.5 | 73.1 |
| (+16 mesh) | | | | |
| (grams) | | | | |

UC1240 and AC816 are designations of bituminous coal based activated carbon media. UC1240 media designates the size of the media particles whereby greater than 95% of the particles pass through a 12 mesh sieve but greater than 95% are retained by a 40 mesh sieve. Similarly, AC816 designates the size of the media particles whereby greater than 95% of the particles pass through a no. 8 mesh sieve but greater than 95% are retained by a no. 16 mesh sieve. In particular, UC1240 media refers to ULTRACARB® 1240 activated carbon and AC816 refers to AQUACARB® 816 activated carbon, both of which are commercially available from Siemens Water Technologies Corp. The systems and techniques of the invention are not limited to such sized particles and one or more further embodiments of the invention may utilize other particles distribution ranges.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

Those skilled in the art should appreciate that the parameters and configurations described herein are exemplary and that actual parameters and/or configurations will depend on the specific application in which the systems and techniques of the invention are used. Those skilled in the art should also recognize or be able to ascertain, using no more than routine experimentation, equivalents to the specific embodiments of the invention. For example, the utilization of the systems and techniques of the invention may be applied in processes that treat fluids having cationic as well as anionic contaminants. Also, the amount of filter media utilized in any one or more embodiments of the invention is not limited to the above-mentioned amount and the invention can be practiced utilizing an amount of, for example, stratified activated carbon, that provides a desired level of treatment for a desired period of service. It is therefore to be understood that the embodiments described herein are presented by way of example only and that, within the scope of the appended claims and equivalents thereto; the invention may be practiced otherwise than as specifically described.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims. Further, acts, elements, and features discussed only in connection with one embodiment are not intended to be excluded from a similar role in other embodiments.

As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims or specification to modify or identify a claim element or component does not by itself connote any priority, precedence, or order of one claim element over another or the temporal order in which acts of a method are performed or assemblies are arranged, but are used merely as labels to distinguish one claim element having a certain name from another element having a same name, but for use of the ordinal term, to distinguish the claim elements.

What is claimed is:

1. A method of facilitating fluid filtration in a filtration bed, comprising:
providing a first activated carbon layer, at least a portion thereof comprising functionalized activated carbon; and
providing a second activated carbon layer in fluid communication downstream of the first activated carbon layer.

2. The method of claim 1, wherein the act of providing the first activated carbon layer comprises functionalizing activated carbon with at least one cationic compound.

3. The method of claim 2, wherein the act of providing the first activated carbon layer comprises contacting activated carbon particles with a cationic compound selected from the group consisting of quaternary ammonium compounds, amine compounds, iminic compounds, imidic compounds, amidic compounds, pyridinic compounds, pyrrolic compounds, and derivatives or analogs thereof.

4. The method of claim 2, wherein the act of functionalizing the activated carbon comprises exposing activated carbon to a solution comprising cetylpyridinium chloride.

5. The method of claim 1, wherein the act of providing the first activated carbon layer comprises pre-loading activated carbon with a cetylpyridinium compound.

6. The method of claim 1, further comprising an act of fluidizing the filtration bed.

7. The method of claim 1, further comprising an act of re-activating the first activated carbon layer.

8. The method of claim 1, wherein the act of providing the first activated carbon layer comprises an act of providing functionalized activated carbon having an average size greater than an average size of activated carbon provided in the second activated carbon layer.

9. The method of claim 1, wherein the act of providing the first activated carbon layer comprises an act of providing functionalized activated carbon having a density less than a density of the activated carbon in the second activated carbon layer.

10. The method of claim 1, wherein the act of providing the second activated carbon layer comprises disposing activated carbon in a filter bed.

11. The method of claim 10, wherein the act of providing the first activated carbon layer comprises disposing functionalized activated carbon in the filter bed.

12. The method of claim 1, further comprising an act of fluidly connecting a pre-treatment system upstream of the filtration bed.

13. The method of claim 1, further comprising an act of fluidly connecting a post-treatment system downstream of the filtration bed.

14. A filtration bed comprising:
a first activated carbon layer comprising functionalized activated carbon particles; and
a second activated carbon layer in fluid communication with the first activated carbon layer.

15. The filtration bed of claim 14, wherein at least a portion of the functionalized activated carbon particles comprises at least one cationic compound selected from the group consisting of quaternary ammonium compounds, aminic compounds, iminic compounds, imidic compounds, amidic compounds, pyridinic compounds, pyrrolic compounds, and derivatives or analogs thereof.

16. The filtration bed of claim 14, wherein at least a portion of the functionalized activated carbon particles comprise a cationic compound.

17. The filtration bed of claim 16, wherein the cationic compound comprises an organic cationic compound.

18. The filtration bed of claim 16, wherein at least a portion of the functionalized activated carbon particles comprise a cetylpyridinium compound.

19. The filtration bed of claim 18, wherein at least a portion of the second activated carbon layer comprises virgin activated carbon particles.

20. The filtration bed of claim 18, wherein at least a portion of the second activated carbon layer comprises re-activated activated carbon particles.

21. The filtration bed of claim 14, wherein the second activated carbon layer comprises particles having an average density greater than an average density of the functionalized activated carbon particles.

22. The filtration bed of claim 14, further comprising a pre-treatment system fluidly connected upstream of the first activated carbon layer.

23. The filtration bed of claim 14, wherein the second activated carbon layer comprises particles having an average density less than an average density of the functionalized activated carbon particles.

24. The filtration bed of claim 14, wherein the second activated carbon layer comprises particles having an average particle size less than an average particle size of the functionalized activated carbon particles.

25. The filtration bed of claim 14, wherein the second activated carbon layer comprises particles having an average particle size greater than an average particle size of the functionalized activated carbon particles.

26. The filtration bed of claim 14, further comprising a source of fluid to be treated fluidly connected upstream of the filtration bed.

27. The filtration bed of claim 26, wherein the fluid to be treated comprises at least one compound selected from the group consisting of a perchlorate, an arsenate, a chromate, and a bromate.

28. The filtration bed of claim 27, wherein the at least one compound has a concentration in the fluid to be treated of at least 1 ppb.

29. The filtration bed of claim 14, wherein the filter bed is contained in a single housing.

30. A method of treating water comprising an act of introducing water to be treated into a stratified filter bed comprising an upstream layer of functionalized activated carbon particles and a downstream layer of non-functionalized activated carbon particles.

31. The method of claim 30, wherein at least a portion of the functionalized activated carbon particles comprises an organic cationic polymer.

32. The method of claim 30, wherein at least a portion of the functionalized activated carbon particles comprises at least one quaternary ammonium compound.

33. The method of claim 32, wherein the quaternary ammonium compound comprises a cetylpyridinium compound.

34. The method of claim 30, further comprising an act of pre-treating the fluid to be treated upstream of the stratified filter bed.

35. The method of claim 30, further comprising an act of monitoring a concentration of at least one compound in an effluent stream from the stratified filter bed.

36. The method of claim 30, further comprising an act of re-activating at least a portion of the functionalized activated carbon particles.

37. The method of claim 36, further comprising an act of re-activating at least a portion of the non-functionalized activated carbon particles.

38. The method of claim 37, further comprising an act of re-stratifying the filter bed after performing the act of re-activating at least a portion of the non-functionalized activated carbon particles.

39. The method of claim 38, further comprising an act of re-introducing water to be treated into the re-stratified filter bed.

40. The method of claim 30, wherein the filter bed is substantially contained in a single housing.

41. The method of claim 40, wherein the water to be treated comprises at least one compound selected from the group consisting of perchlorates, arsenates, chromates, and bromates.
